(19) United States
(12) Patent Application Publication
(10) Pub. No.: US 2017/0305667 A1
(43) Pub. Date: Oct. 26, 2017

(54) Hand-Operated Container

(71) Applicant: Sarah Nakib, Bethesda, MD (US)

(72) Inventor: Sarah Nakib, Bethesda, MD (US)

(21) Appl. No.: 15/137,480

(22) Filed: Apr. 25, 2016

(51) Int. Cl. B65F 1/16; B65F 1/06

(52) U.S. Cl. CPC B65F 1/1623; B65F 1/1646; B65F 1/068; B65F 2240/132; B65F 2210/126

(57) ABSTRACT

A hand-operated container is provided that allows a user to place refuse or used diapers within the interior of the container while operating the lid thereof using a hand-operated lift mechanism. The handle of the lift mechanism is disposed along the upper half of the sidewall of the receptacle, thereby allowing a seated user to engage the handle. Within the interior of the receptacle may be a set of biased doors that engage a receptacle liner therein, which are used maintain the liner in a closed state while the liner retains refuse within its interior. Along the sidewall of the receptacle may further comprise an access door used to remove filled liners, whereby the liners may be withdrawn from a continuous liner cartridge above the biased doors and separated using a cutting element disposed along the interior of the access door.

### BACKGROUND OF THE INVENTION

### Field of the Invention

The present invention relates to refuse containers and diaper pails. More specifically, the present invention relates to a diaper pail that can be opened with a handle disposed along the upper part of the pail sidewalls, thereby allowing the pail to be opened by hand.

The present invention provides a container, receptacle, or pail that includes a hand-operated lid and an internal assembly for securing refuse therein without letting the odors of the refuse escape from the interior. In particular, the lid of the container is operated by a lift mechanism and a handle disposed along the sidewalls of the container. Within the container interior is a pair of biased doors adapted to pinch a receptacle liner disposed therein, whereby the biased doors secure the liner in a closed state and retain refuse, diapers, and other items within the liner interior. The present invention is particular suited for use as a diaper pail for adult diapers, whereby the pail can be placed adjacent to a toilet or bedside and operated by hand to open and close the pail.

Common diaper disposal methods for adults who suffer from incontinence are unsanitary, inefficient, and emit a strong odor. To open most diaper pails, a foot lever is provided to lift the lid into an open state. The position of the foot lever is adjacent to the lower surface of the pail, which can be uncomfortable to operate while an individual is seated. This is particularly true for users on a toilet, or for those with limited mobility. The present invention provides an improved diaper pail device that provides a hand-operated handle along the sidewalls of the pail to open the pail, and an internal assembly to enclose and secure receptacle liners to prevent odors from escaping.

There currently exists a need for a diaper pail made and marketed for adults who wear adult diapers. The present invention provides such a device, whereby the diaper pail is ergonomic and suited for persons with limited mobility or for operation while the user is in a seated position. For example, while on a toilet, it is much more ergonomic to operate a hand-operated mechanism than a foot-operated mechanism. There are currently no diaper pails that allow one to open a receptacle or diaper pail with a hand-operated mechanism. Given that the elderly population is growing, the present invention provides assistance to many in disposing of adult diapers in an ergonomic method and in the privacy of their bathroom in an odor free manner.

### SUMMARY OF THE INVENTION

The following summary is intended solely for the benefit of the reader and is not intended to be limiting in any way. The present invention provides a new hand-operated pail that can be utilized for providing convenience for the user when disposing of refuse and used diapers and hand-opening the lid of the pail.

It is therefore an object of the present invention to provide a new and improved hand-operated pail that has all of the advantages of the prior art and none of the disadvantages.

It is another object of the present invention to provide a hand-operated pail that comprises a receptacle having upstanding sidewalls, an upper surface, a lower surface, an interior volume, and a hinged lid disposed along the upper surface of the receptacle.

Another object of the present invention is to provide a hand-operated pail in which the hinged lid is pivotable from a first pivot point adjacent to the upper surface of the receptacle and pivotable between an open position and a closed position over the upper surface of the receptacle.

Another object of the present invention is to provide a hand-operated pail wherein the upstanding sidewalls of the receptacle further comprise an upper half and a lower half, whereby the upper half is disposed adjacent to the upper surface and the lower half is disposed below the upper half.

Another object of the present invention is to provide a hand-operated pail in which a handle is disposed along one of the upstanding sidewalls of the receptacle and along the upper half thereof such that the handle is adapted to be engaged by the hand of a user.

Another object of the present invention is to provide a hand-operated pail in which the handle is connected to the hinged lid via a lift mechanism, whereby downward motion of the handle causes the hinged lid to lift into the open position.

Another object of the present invention is to provide a hand-operated pail in which the lift mechanism further comprises a perimeter ring that extends around the receptacle. The perimeter ring further comprises a plurality of tangential supports that extend inward and engage slots disposed in the upstanding sidewalls of the receptacle. The perimeter ring slides vertically along the receptacle sidewalls when pressed or released by the handle.

Another object of the present invention is to provide a hand-operated pail in which a rear upstanding member extends from the perimeter ring and engages the hinged lid at a second pivot point, whereby downward motion of the perimeter ring pulls downward on the second pivot point. The hinged lid pivots about the first pivot point into the open position when the second pivot point is pulled downward by the rear upstanding member and the downward motion of the perimeter ring.

Another object of the present invention is to provide a hand-operated pail in which the lift mechanism comprises a first upstanding member affixed to the handle and extending downward toward the lower surface of the receptacle. The first upstanding member is disposed along a front sidewall of the receptacle while a rear upstanding member extends along a rear sidewall of the receptacle. Connecting the handle and the rear upstanding member is a rocker arm disposed along the lower surface of the receptacle and affixed to a rocker pivot point.

Another object of the present invention is to provide a hand-operated pail in which the rocker arm has a first end connected to the first upstanding member and a second end connected to the rear upstanding member. In operation, downward motion of the handle moves the first upstanding member downward and the first end of the rocker arm downward, while lifting the second end of the rocker arm and the rear upstanding member upwards.

Another object of the present invention is to provide a hand-operated pail in which the rear upstanding member engages the hinged lid at a second pivot point. When the lid is being operated, the hinged lid pivots about the first pivot point into the open position when the second pivot point is forced upward by the rear upstanding member and the upward motion of the second end of the rocker arm.

Another object of the present invention is to provide a hand-operated pail in which the interior volume of the receptacle further comprises a central opening and a ledge adapted to support an upper opening of an open receptacle liner within the central opening.

Another object of the present invention is to provide a hand-operated pail in which the interior volume further comprises a pair of biased doors that are adapted to pinch the receptacle liner closed below the ledge to separate items within receptacle liner from the upper opening thereof.

Another object of the present invention is to provide a hand-operated pail in which the biased doors are hinged and spring biased into a closed state, whereby the biased doors swing downward into an open state when items are pressed through the biased doors.

Another object of the present invention is to provide a hand-operated pail in which an upper compartment is disposed above the ledge that is adapted to support a cartridge of liners, whereby the cartridge of liners comprises a rounded roll of receptacle liners that can be pulled into central opening and pinched by the biased doors.

Another object of the present invention is to provide a hand-operated pail in which a lower access door disposed along the lower half of one of the upstanding sidewalls of the receptacle. The lower access door is hingedly affixed along one edge to the receptacle.

Another object of the present invention is to provide a hand-operated pail in which the lower access door further comprises an interior surface. A cutting element is disposed along the interiors surface of the lower access door, which is adapted to separate receptacle liners disposed within the interior volume of the receptacle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the hand-operated pail of the present invention.

FIG. 2 shows another embodiment of the hand-operated pail of the present invention.

FIG. 3 shows an internal view of the hand-operated pail of the present invention, in which a pair of biased doors and a continuous liner are used to support refuse placed within the pail.

FIG. 4 shows an overhead perspective view of a cartridge of liners being placed within the interior of the hand-operated pail.

FIG. 5 shows a view of the lower access door of the hand-operated pail.

### DETAILED DESCRIPTION OF THE INVENTION

Reference is made herein to the attached drawings. Like reference numerals are used throughout the drawings to depict like or similar elements of the hand-operated pail of the present invention. For the purposes of presenting a brief and clear description of the present invention, the preferred embodiment will be discussed as used for accepting and enclosing refuse and waste, including adult diapers therein. The figures are intended for representative purposes only and should not be considered to be limiting in any respect.

The hand-operated pail of the present invention is one that is adapted to be used by any able user, but one that is particularly useful for seated users who can engage a handle along the upper half of the pail when opening the lid thereof. In particular, the present invention is a receptacle pail that supports refuse, whereby a hinged lid is provided over the open upper. The hinged lid is supported by a lift mechanism, which allows the lid to pivot upwards to open and pivot downwards to close over the pail opening. A handle is disposed along the pail sidewalls that operates the lift mechanism, whereby the handle is ideally suited for being operated by hand and by a seated user. Therefore, the pail may be placed adjacent to a toilet or seat and operated by the seated user by hand.

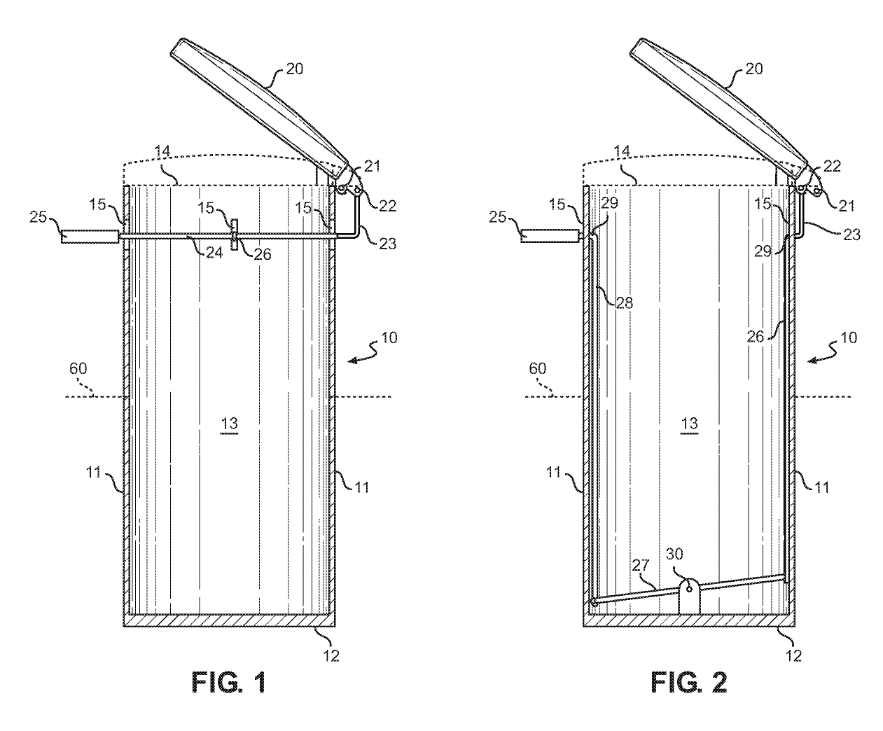

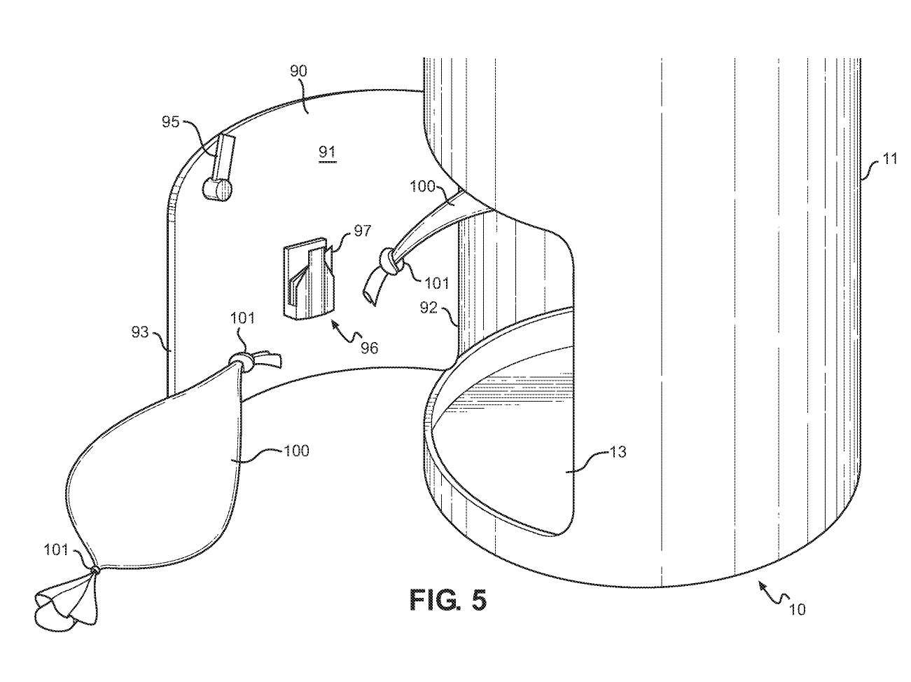

Referring now to FIGS. 1-5, embodiments of the hand-operated pail are shown. The hand-operated diaper pail comprises a receptacle 10 having upstanding sidewalls 11, an upper surface 14, a lower surface 12, and an interior volume 13. Extending over the upper surface 14 is a hinged lid 20 that pivots between an open position and a closed position. The hinged lid 20 is connected to a lift mechanism that pivots the lid between the open and closed position, whereby a handle 25 is provided to operate the lift mechanism. The handle 25 is disposed along one of the upstanding sidewalls 11 of the receptacle 10 and along the upper half thereof such that the handle 25is adapted to be engaged by the hand of a user. That is, the handle 25 preferably disposed above the midsection 60 of the receptacle 10 such that the handle 25 is in an elevated position relative to the lower surface 12. This makes the handle 25 more accessible to a user from above, such as when the user is seated and the receptacle 10 is positioned on the floor adjacent thereto.

The hinged lid 20 is pivotable over the upper surface 14 of the receptacle 10 and controlled by the lift mechanism. The lid 20 includes a first pivot point 21 adjacent to the upper surface 14 of the receptacle 10, which is the pivot point about which the lid rotates. This pivot point 21 is preferably along a sidewall 11 of the receptacle 10 opposite of the handle 25. Along with the first pivot point 21, a second pivot point 22 is provided along the lid 20, which is connected to the lift mechanism and controlled by the position of the handle 25. In some embodiments, the second pivot point 22 is located outboard of the first pivot point 21 relative to the sidewall 11 of the receptacle 10. In other embodiments, the second pivot point 22 is inboard of the first pivot point 21. The lift mechanism draws on the second pivot point 22, thereby causing the first pivot point 21 to act as a static pivot point and the lid 20 to lift or lower corresponding to the position of the second pivot point 22. In this way, motion of the second pivot point 22 raises or lowers the lid 20 depending on the relative position of the pivot points 21, 22.

The upstanding sidewalls 11 of the receptacle 10 comprise an upper half and a lower half, whereby the upper half is disposed adjacent to the upper surface 14 and the lower half is disposed below the upper half. The upper half and lower half are divided by the midsection 60 of the receptacle, which is approximately equidistant between the upper surface 14 and the lower surface 12 of the receptacle along the sidewalls 11. The handle is preferably disposed along the upper half of the receptacle such that the handle 25 is more easily engaged by the hand of a user. In turn, the handle 25 is connected to the hinged lid 20 via the lift mechanism, whereby downward motion of the handle 25 causes the hinged lid 20 to lift into the open position.

Referring now to FIG. 1, an embodiment of the hand-operated pail is shown. In this embodiment, the lift mechanism comprises a perimeter ring 24 that extends around the receptacle 10 and connects the handle 25 to a rear upstanding member 23. The rear upstanding member 23 is preferably a vertically disposed member that extends upwards from the perimeter ring 24 and engages the hinged lid 20 at the second pivot point 22 thereof. The connection between the second pivot point 22 and the upstanding member 23 is preferably a pin joint or equivalent, whereby downward motion of the upstanding member 23 draws the second pivot point 22 downward. The downward motion of the upstanding member 23 is accomplished by way of the handle 25, whereby the handle 25 is connected to the perimeter ring 24 and the perimeter ring moves vertically along the sidewalls 11 of the receptacle 10 to draw the upstanding member 23 downwards.

The perimeter ring 24 is a rounded member extending along the sidewalls 11 of the receptacle and supported therealong. The perimeter ring 24 includes a plurality of tangential supports 26 that extend inward and engage slots 26 disposed along the upstanding sidewalls 11 of the receptacle 10. In this way, the tangential supports 26 support the perimeter ring along the sidewalls 11 and maintain the perimeter ring 23 in a substantially level condition as the handle 25 is depressed and released. In operation, the perimeter ring 24 slides vertically along sidewalls 11 of the receptacle 10 when pressed or released by the handle 25. The rear upstanding member 23 extends upwards from the perimeter ring 24 opposite of the handle 25 and engages the hinged lid 20 at a second pivot point 22. Downward motion of the perimeter ring 24 therefore pulls downward on the second pivot point 22, and upward motion of the handle 25 returns the lid 20 into a closed position over the upper surface 14 of the receptacle 10. The hinged lid 20 pivots about the first pivot point 21 when the upstanding member 23 acts upon the second pivot point 22. Therefore, the lid 20 is moved into the open position when the second pivot point 22 is pulled downward by the rear upstanding member 23 and the downward motion of the perimeter ring 24.

Referring now to FIG. 2, a second embodiment of the hand-operated pail is shown. In this embodiment, the lift mechanism comprises a first upstanding member 28 affixed to the handle 25 and a rear upstanding member 26 extending vertically along opposite sidewalls 11 of the receptacle 10. The first upstanding member 28 extends downward toward the lower surface 12 of the receptacle 10 and is disposed along a front sidewall thereof. The rear upstanding member 11 extends along a rear sidewall of the receptacle, opposite of the first upstanding member 28. Connecting the first upstanding member 28 and the rear upstanding member 25 is a rocker arm 27 disposed along the lower surface 12 of the receptacle 10. The rocker arm 27 is pivotably affixed to a rocker pivot point 30 therealong.

The rocker arm 27 has a first end and a second end, whereby the first end is pivotably affixed to the first upstanding member 28 and the second end is pivotably affixed to the rear upstanding member 26. In this manner, downward motion of the first upstanding member 28 move the first end of the rocker arm 27 downward and lifts the second end of the rocker arm 27 and the rear upstanding member 26 upwards. The handle 25 is connected to the first upstanding member 28 via a horizontal member 29 that may be positioned through a slot 15 in the receptacle sidewall 11. Likewise the rear upstanding member 26 has an upper portion 23 and horizontal member 29 therebetween, whereby the horizontal member may be positioned through a slot 15 in the receptacle sidewall 11. When the handle 25 is moved downward, the first upstanding member 28 and the first end of the rocker arm 27 move downward. This lifts the second end of the rocker arm 27 and elevates the rear upstanding member 26. The upstanding members may be disposed within the interior 13 of the receptacle 10, may be disposed along an outer enclosed chamber, or finally may be disposed along the exterior of the receptacle 10.

Along the rear of the receptacle, the upper portion 23 of rear upstanding member 26 engages the hinged lid 20 at a second pivot point 22. The hinged lid 20 pivots about the first pivot point 21 into the open position when the second pivot point 22 is forced upwardly by the rear upstanding member 26 and by the upward motion of the second end of the rocker arm 27. In this way, the second pivot point 22 is inboard of the first pivot point 21 such that the first pivot point 21 is a static joint and the second pivot point 22 moves commensurately with the upper portion 23 of the rear upstanding member 26.

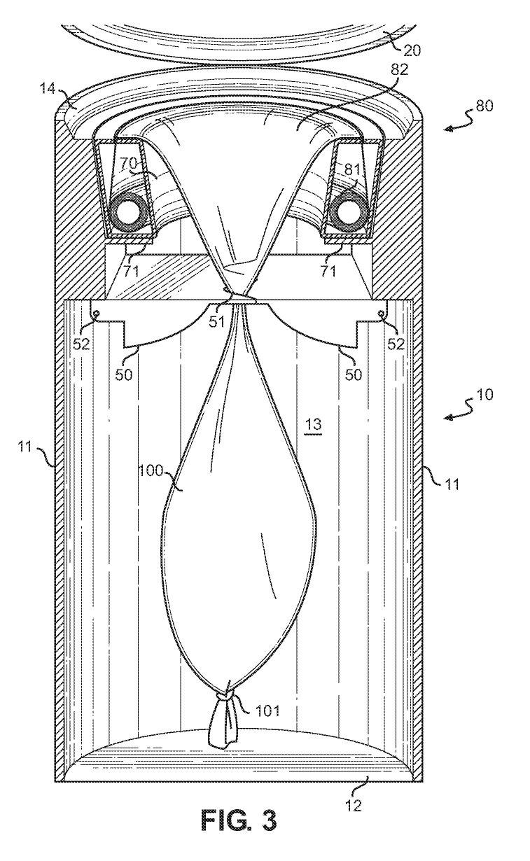

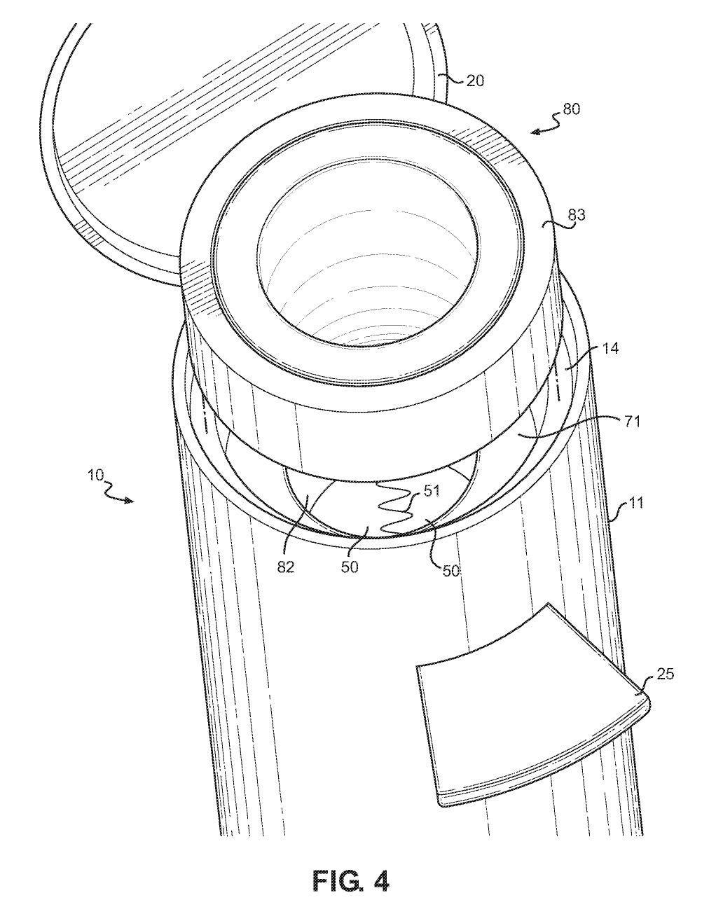

Along with a hand-operated lift mechanism, the present invention also includes a continuous internal liner system and an internal closure maintains scent and odors within the interior thereof. As shown in FIGS. 3 and 4, the receptacle 10 preferably has an interior volume 13 that comprises a central opening 82 and a ledge 71 adapted to support a liner cartridge 80 therein. The ledge 71 supports the liner cartridge 80 therein, whereby the liner cartridge dispenses a continuous series of receptacle liners 100 into the interior of the receptacle that receive refused placed therein.

The liner cartridges 80 are replaceable units that support a continuous length of receptacle liners 100. The cartridge 80 preferably comprises a rounded housing 83 in which the continuous liners are disposed within the housing in rolled form 81. Within the central interior of the rounded housing 83 is an open interior, whereby the liners deploy from their rolled state 81 and into the open interior of the cartridge 80. When placed within the central opening 82 of the receptacle, the cartridge 80 is supported by the receptacle ledge 71 and the liners 100 can be dispensed into the central opening 82 of the receptacle. In this way, the user can lift the lid 20 of the receptacle and place refuse into the interior of the liners 100, which are positioned within the central opening 82 of the receptacle and in an open state.

Positioned below the interior ledge 71 of the receptacle and within the interior volume 13 thereof is a pair of biased doors 50 that are adapted to pinch the receptacle liner closed below the ledge 71. The biased doors 50 pinch the liner 100 positioned within the central opening 82 of the receptacle 10. This allows items to be placed within the liner interior and pressed through the biased doors 50 and into the lower portion of the receptacle 10, whereafter the biased doors 50 pinch the liner closed. The lower extent 101 of the liner 100 is knotted closed by the user, while the biased doors 50 pinch the liner above refuse placed within the liner interior. The upper end of the liner extends above the biased doors and is connected to the continuous roll 81 of liners within the liner cartridge 80. This keeps odors within the interior of the liner disposed within the interior of the receptacle, whereby the biased doors 50 form together at an interface 51 and pinch the liner therebetween.

The biased doors 50 are spring biased members that rotate between a closed state and a downwardly open state. The doors 50 are hinged at a hinge pin 52 along the lower surface of the ledge 71 or along the sidewalls 11 of the receptacle. A torsion spring about the hinge pin is used to bias the doors 50 into the closed state, and shown in FIG. 3. When a user places refuse into the liner interior, he or she presses the refuse through the doors 50 and into the liner interior. The doors are hinged to open downwardly as the user presses refused therethrough, and are biased to return to a closed state whereby the inner edges of the doors form an interface 51 that pinches the liner 100 therebetween.

When the liner 100 is full, the liner can be replaced by removing the filled liner, cutting the liner above the refuse, and retying the knot 101 along the lower end of the liner. To assist this process, a lower access door 90 is disposed along the lower half of one of the upstanding sidewalls 11 of the receptacle 10. The lower access door 90 is hingedly affixed along one edge 92 to the receptacle sidewalls 11 whereby the access door 90 can be rotated outward from the sidewalls 11 when accessing the interior volume 13 of the receptacle 10. In addition, the lower access door 90 further comprises an interior surface 91, whereby the interior surface supports a liner cutting element 96 therealong. The cutting element 96 is preferably a cutting edge 97 or razor that is used to readily cut the liner 100 above the refuse therein, whereby the liner is knotted 101 on both sides of the cut to enclose the refuse and to secure closed the lower end of the new liner disposed within the receptacle.

The access door 90 preferably has a latch 95 or closure element disposed along an edge 93 thereof such that the access door 90 remains closed against the sidewall 11 of the receptacle during normal use. When removing a filled liner 100, the access door 90 is opened and pivoted away from the sidewall 11. The filled liner 100 is withdrawn from the interior 13 of the receptacle and the liner is cut by the cutting element 93 disposed on the access door 90. The cutting element separate the receptacle liner such that a portion of the liner with refuse therein can be separated from a portion of the liner that is empty and disposed within the interior 13 of the receptacle 10. The upper end of the filled liner 100 is knotted 101 by the user, and the lower end of the empty liner is knotted to create an enclosed liner within the interior 13 of the receptacle. In this manner, the liner 100 is a continuous sheet of material that is knotted to form lower and upper closures. The liners are dispensed by the cartridge of liners and are pinched by the biased doors. In this manner, the receptacle encloses odors within the interior of the receptacle and allows for the ready deployment of liners into the receptacle interior.

Overall, the present invention provides a new and useful pail that includes a hand-operated lift mechanism and an optional liner system. It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hand-operated diaper pail, comprising:
a receptacle having upstanding sidewalls, an upper surface, a lower surface, and an interior volume;
a hinged lid disposed along the upper surface of the receptacle;
the hinged lid being pivotable from a first pivot point adjacent to the upper surface of the receptacle, and pivotable between an open position and a closed position over the upper surface of the receptacle;
the upstanding sidewalls of the receptacle further comprising an upper half and a lower half, whereby the upper half is disposed adjacent to the upper surface, and the lower half is disposed below the upper half;
a handle disposed along one of the upstanding sidewalls of the receptacle and along the upper half thereof such that the handle is adapted to be engaged by the hand of a user;
whereby the handle is connected to the hinged lid via a lift mechanism, whereby downward motion of the handle causes the hinged lid to lift into the open position.

2) The hand-operated diaper pail of claim 1, wherein:
the lift mechanism further comprises a perimeter ring that extends around the receptacle;
the perimeter ring further comprises a plurality of tangential supports that extend inward and engage slots disposed in the upstanding sidewalls of the receptacle;
whereby the perimeter ring can slide vertically along sidewalls of the receptacle when pressed or released by the handle;
whereby a rear upstanding member extends from the perimeter ring and engages the hinged lid at a second pivot point, whereby downward motion of the perimeter ring pulls downward on the second pivot point; and
whereby the hinged lid pivots about the first pivot point into the open position when the second pivot point is pulled downward by the rear upstanding member and the downward motion of the perimeter ring.

3) The hand-operated diaper pail of claim 1, wherein:
the lift mechanism further comprises a first upstanding member affixed to the handle and extending downward toward the lower surface of the receptacle;
the first upstanding member being disposed along a front sidewall of the receptacle;
a rear upstanding member extending along a rear sidewall of the receptacle;
a rocker arm disposed along the lower surface of the receptacle and affixed to a rocker pivot point;
the rocker arm having a first end connected to the first upstanding member and a second end connected to the rear upstanding member;
whereby downward motion of the handle moves the first upstanding member downward and the first end of the rocker arm downward, and lifts the second end of the rocker arm and the rear upstanding member upwards;
whereby the rear upstanding member engages the hinged lid at a second pivot point;
whereby the hinged lid pivots about the first pivot point into the open position when the second pivot point is forced upward by the rear upstanding member and the upward motion of the second end of the rocker arm.

4) The hand-operated diaper pail of claim 1, wherein:
the interior volume of the receptacle further comprises a central opening and a ledge adapted to support an upper opening of an open receptacle liner within the central opening; and
wherein the interior volume further comprises a pair of biased doors that are adapted to pinch the receptacle liner closed below the ledge to separate items within receptacle liner from the upper opening thereof.

5) The hand-operated diaper pail of claim 4, wherein:
the biased doors are hinged and spring biased into a closed state, whereby the biased doors swing downward into an open state when items are pressed through the biased doors.

6) The hand-operated diaper pail of claim 4, wherein:
an upper compartment is disposed above the ledge that is adapted to support a cartridge of liners, whereby the cartridge of liners comprises a rounded roll of receptacle liners that can be pulled into central opening and pinched by the biased doors.

7) The hand-operated diaper pail of claim 1, further comprising:
a lower access door disposed along the lower half of one of the upstanding sidewalls of the receptacle;
whereby the lower access door is hingedly affixed along one edge to the receptacle.

8) The hand-operated diaper pail of claim 7, wherein:
the lower access door further comprises an interior surface; and
wherein a cutting element is disposed along the interiors surface of the lower access door that is adapted to separate receptacle liners disposed within the interior volume of the receptacle.
